(19) United States
(12) Patent Application Publication
(10) Pub. No.: US 2023/0267902 A1
(43) Pub. Date: Aug. 24, 2023

(54) INPUT DEVICE AND ELECTRONIC MUSICAL INSTRUMENT

(71) Applicant: YAMAHA CORPORATION, Hamamatsu-shi (JP)

(72) Inventor: Shinichi OHTA, Hamamatsu-shi (JP)

(21) Appl. No.: 18/112,619

(22) Filed: Feb. 22, 2023

(30) Foreign Application Priority Data
Feb. 22, 2022 (JP) 2022-026182

(51) Int. Cl. G10H 1/34; G10H 1/00

(52) U.S. Cl. CPC G10H 1/34; G10H 1/0008; G10H 2220/161; G10H 2220/061

(57) ABSTRACT

An input device includes a touch bar having an operation area for receiving a contact operation performed by a user, a switcher that switches between a first mode (continuous mode) in which a continuously changing value is receivable in response to an operation performed on the operator and a second mode (grid mode) different from the first mode, and a section presenter that presents section information representing a plurality of sections of the operation area during the second mode.

### BACKGROUND

### Technical Field

The present disclosure relates to an input device and an electronic musical instrument including the input device.

### DESCRIPTION OF RELATED ART

There is an electronic musical instrument that includes a slider with which a slide operation can be performed as an input device. A user can perform various input operations on the electronic musical instrument such as an operation of inputting a sound volume by performing a slide operation on the slider.

JP 2013-008252 A discloses a slider. The user can perform two operations which are a slide operation and a push operation on the slider disclosed in JP 2013-008252 A. A push operation is performed with utilization of the same operation interface as the interface used for a slide operation.

### SUMMARY

The slider is an input device that enables a continuous operation and is highly convenient for the user. On the other hand, since values can be continuously input with use of the slider, the operability of the slider largely depends on the user's feeling.

An object of the present disclosure is to improve operability of a slider.

An input device according to one aspect of the present disclosure includes an operator having an operation area for receiving a contact operation performed by a user, a switcher that switches between a first mode in which a continuously changing value is receivable in response to an operation performed on the operator and a second mode different from the first mode, and a section presenter that presents section information representing a plurality of sections of the operation area during the second mode.

An electronic musical instrument according to another aspect of the present disclosure includes the input device, and a parameter setter that sets a music parameter in accordance with operation position information output by the outputter.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a diagram showing the appearance of an electronic musical instrument according to an embodiment;

FIG. 2 is a block diagram of the electronic musical instrument according to the embodiment;

FIG. 3 is a block diagram showing the functions of an electronic musical instrument according to the embodiment;

FIG. 4 is a diagram showing an input device operating in a continuous mode;

FIG. 5 is a diagram showing the input device operating in a grid mode;

FIG. 6 is a diagram showing the input device operating in the grid mode;

FIG. 7 is a flowchart showing a mode switching method according to the embodiment;

FIG. 8 is a flowchart showing a parameter setting method according to the embodiment;

FIG. 9 is a conceptual diagram of a parameter setting in the continuous mode;

and

FIG. 10 is a conceptual diagram of the parameter setting in the grid mode.

### DETAILED DESCRIPTION

### [1] Configuration of Electronic Musical Instrument

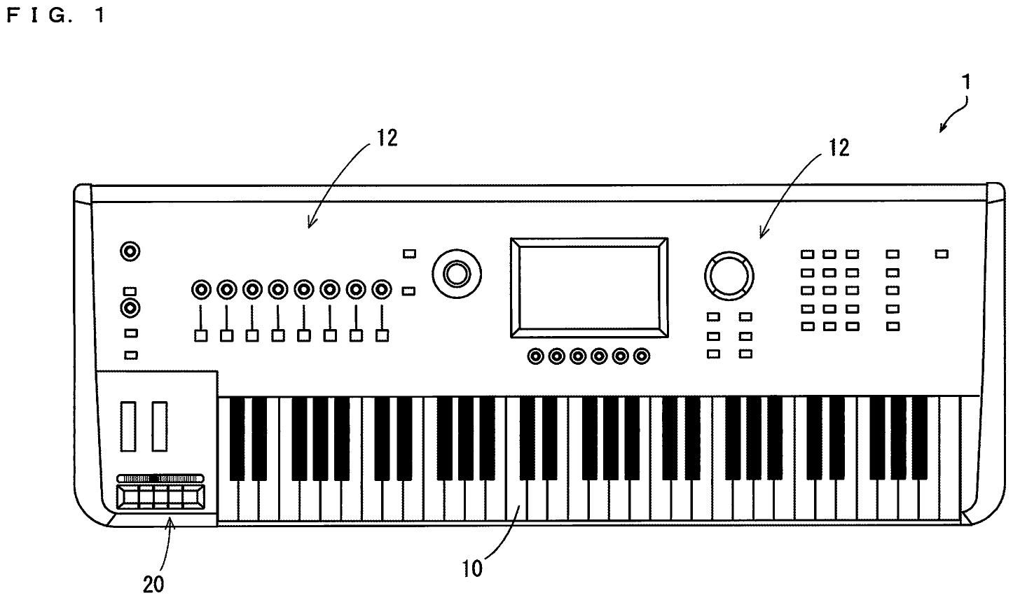

FIG. 1 is a diagram showing the appearance of an electronic musical instrument 1 according to the embodiment. In the present embodiment, an electronic keyboard musical instrument is described as the electronic musical instrument 1, by way of example. The electronic musical instrument 1 includes a keyboard 10. An operation interface 12 including operation units such as a dial, a button and a slider, and display units such as a display and an indicator is arranged in the rear portion of the keyboard 10. An input device 20 according to the present embodiment is arranged next to the keyboard 10. The input device 20 is also part of the operation interface 12.

The input device 20 of the present embodiment is switchable between a continuous mode in which a continuously changing value can be received in response to a user operation and a grid mode in which a discontinuous value can be received in response to a user operation. In the continuous mode, a user mainly performs a continuous operation on the input device 20. In the grid mode, the user mainly performs a discontinuous operation on the input device 20. The continuous operation refers to an operation of bringing a finger into contact with the surface of an operator and tracing the surface of the operator with the finger while keeping the contact and applying pressure. Further, the discontinuous operation refers to an operation of bringing a finger into contact with the surface of an operator or pushing part of the surface of an operator with the finger. In the continuous mode, the input device 20 functions as a slider, and causes one of various parameters of the electronic musical instrument 1 to change continuously when receiving a slide operation which is a continuous operation performed by the user. In the grid mode, when receiving a discontinuous operation performed by the user, the input device 20 designates one of various parameters of the electronic musical instrument 1 in accordance with a contacted grid position. However, a discontinuous operation may be performed by the user in the continuous mode, or a continuous operation may be performed by the user in the grid mode. When receiving a discontinuous operation performed by the user in the continuous mode, the input device 20 designates one of various parameters of the electronic musical instrument 1 in accordance with a contacted position. When receiving a continuous operation performed by the user in the grid mode, the input device 20 causes one of various parameters of the electronic musical instrument 1 to change discontinuously (discretely).

### [2] Functional Configuration of Electronic Musical Instrument

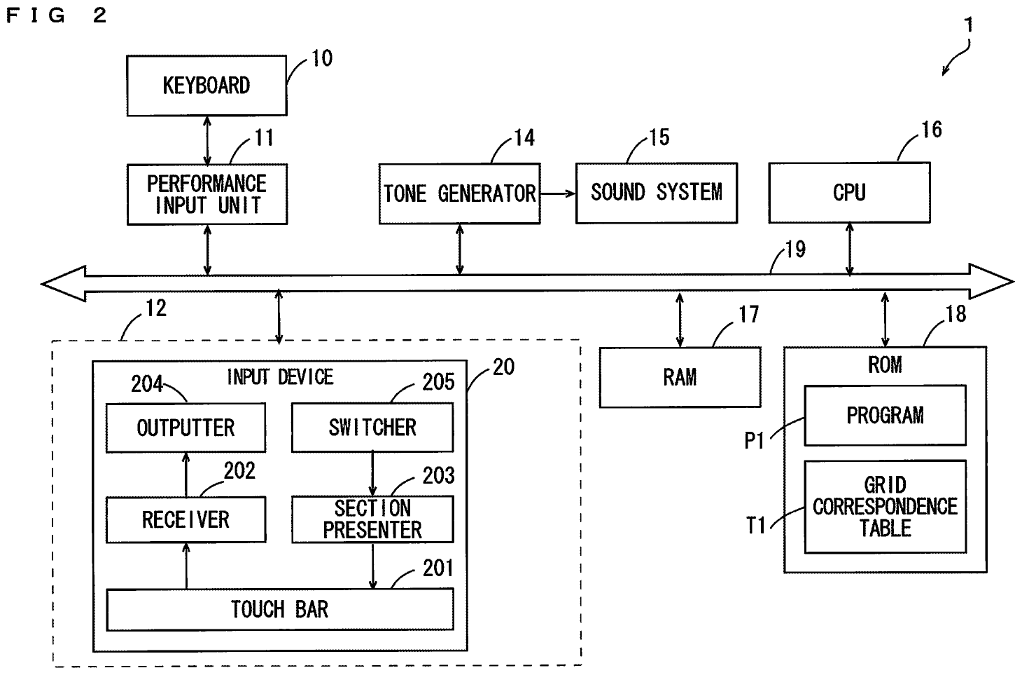

Next, the functional configuration of the electronic musical instrument 1 will be described. FIG. 2 is a block diagram showing the functional configuration of the electronic musical instrument 1. As shown in FIG. 2, the electronic musical instrument 1 includes the keyboard 10, a performance input unit 11, the operation interface 12, a tone generator 14, a sound system 15, a CPU (Central Processing Unit) 16, a RAM (Random Access Memory) 17 and a ROM (Read Only Memory) 18. The operation interface 12 includes the input device 20. The input device 20 includes a touch bar 201, a receiver 202, a section presenter 203, an outputter 204 and a switcher 205. At least the section presenter 203, the outputter 204, and the switcher 205 can be performed by a microprocessor or electronic circuit/circuits (not illustrated), or the CPU 16.

The performance input unit 11 receives musical performance operation information from the keyboard 10. The performance input unit 11 outputs musical performance data representing the contents of a musical performance based on the musical performance operation information. The musical performance data is made of MIDI (Musical Instrument Digital Interface) data or audio data. The operation interface 12 receives operations for adjustment of a musical performance sound, selection of an automatic accompaniment sound, adjustment of the volume of an automatic accompaniment sound, reproduction of a musical performance demonstration sound, on-off of a power supply and various settings. The input device 20 also receives an operation for various settings. The input device 20 may be able to receive a plurality of setting items by a switching operation or may be configured to fixedly receive any of the setting items. Further, the operation interface 12 displays various information in regard to musical performance or settings, for example. The performance input unit 11 and the operation interface 12 are connected to a bus 19.

The RAM 17 is made of a volatile memory, for example, and is used as a work area when the CPU 16 executes a program and temporarily stores various data. The ROM 18 is made of a non-volatile memory, for example, and stores a computer program such as a program P1 and various data such as a grid correspondence table T1. A flash memory such as EEPROM is used as the ROM 18. The CPU 16 executes the program P1 stored in the ROM 18 while utilizing the RAM 17 as a work area, thereby performing a mode switching method and a parameter setting method, described below. The CPU 16, the RAM 17 and the ROM 18 are connected to the bus 19.

The tone generator 14 is connected to the bus 19, and the sound system 15 is connected to the tone generator 14. The tone generator 14 generates a musical sound signal based on the musical performance data received from the performance input unit 11. The sound system 15 includes a digital-analogue (D/A) conversion circuit, an amplifier and a speaker. This sound system 15 converts a musical sound signal provided from the tone generator 14 into an analogue sound signal and generates a sound based on the analogue sound signal. Thus, a musical sound signal is reproduced.

### [3] Functional Configurations of Electronic Musical Instrument and Input Device

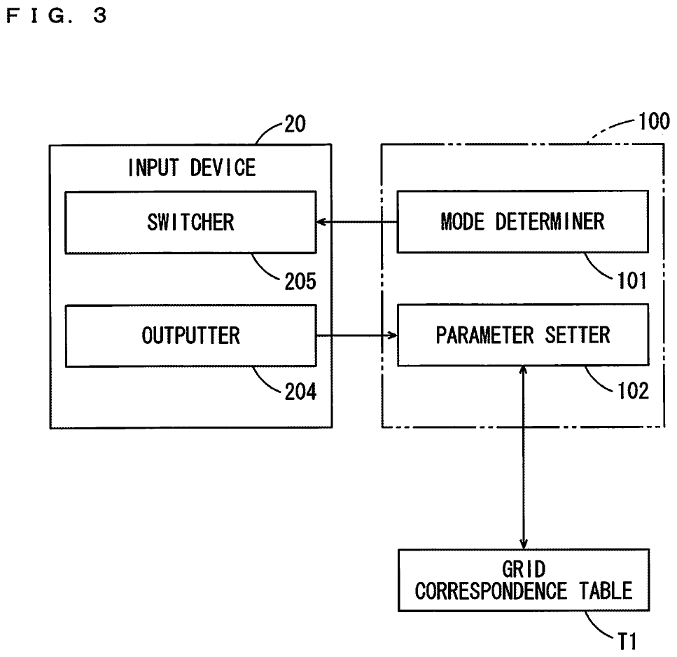

FIG. 3 is a block diagram showing the functions of the electronic musical instrument 1 including the input device 20 in regard to mode switching and parameter setting. The electronic musical instrument 1 includes a controller 100. The controller 100 includes a mode determiner 101 and a parameter setter 102. The controller 100 is a function that is implemented when the program P1 is executed on the CPU 16 with utilization of hardware resources such as the RAM 17.

The mode determiner 101 determines which one of the continuous mode and the grid mode the input device 20 is to be operated in. The mode determiner 101 determines the mode based on a tone color currently set in the electronic musical instrument 1, for example. Alternatively, the mode determiner 101 may determine the mode in accordance with an input operation of the user. The mode determiner 101 notifies the switcher 205 of the input device 20 of mode designation information in accordance with the determined mode.

The parameter setter 102 sets a predetermined parameter of the electronic musical instrument 1. The parameter setter 102 sets a parameter such as a volume or a tone. The parameter setter 102 sets a parameter based on operation position information provided from the outputter 204 of the input device 20.

The switcher 205 switches the mode of the input device 20 based on the mode designation information provided from the mode determiner 101. The switcher 205 instructs the section presenter 203 (see FIG. 2) to display a section indicator 211, described below, in accordance with the switched mode. The section presenter 203 changes the display setting of the section indicator 211 for the touch bar 201 based on the display instruction received from the switcher 205. The touch bar 201 is utilized as a slider in the continuous mode. The section indicator 211 is one example of section information of the present invention.

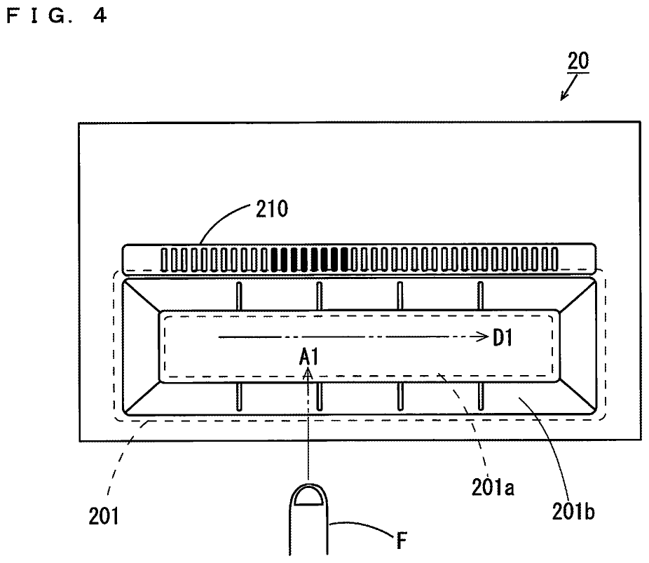

The receiver 202 (see FIG. 2) receives operation position information in accordance with a contact operation performed by the user on the touch bar 201. The touch bar 201 has an operation area 201a (see FIG. 4 and the like) extending in a one-dimensional direction. That is, the touch bar 201 has the operation area 201a on which a continuous operation (slide operation) is performed in the continuous mode and a discontinuous operation is performed in the grid mode. Therefore, the receiver 202 receives operation position information in correspondence with a contact operation performed on the one-dimensional operation area 201a. The receiver 202 provides the operation position information to the outputter 204. The outputter 204 provides the operation position information to the parameter setter 102 (see FIG. 3). In the continuous mode, the parameter setter 102 sets a parameter according to a setting value in correspondence with the operation position information. In the grid mode, the parameter setter 102 sets a parameter according to a setting value determined based on the operation position information and the grid correspondence table T1.

### [4] Configuration of Input Device

FIG. 4 is a diagram showing the input device 20 operating in the continuous mode. The input device 20 includes the touch bar 201 and an indicator 210. The touch bar 201 is an input device that detects a contact operation. As the touch bar 201, a resistive film type (pressure-sensitive type) touch bar, a capacitive type touch bar or the like is utilized, for example. The touch bar 201 is a strip-shaped sensor (ribbon sensor) and has the one-dimensional operation area 201a extending in a D1 direction shown in FIG. 4. A bezel 201b, which is a non-operation area, is arranged around the operation area 201a. The touch bar 201 is constituted by the operation area 201a and the bezel 201b. The touch bar 201 outputs one-dimensional operation position information in regard to the D1 direction in response to a contact operation performed by the user on any location on the operation area 201a.

The indicator 210 displays the position corresponding to a current user operation on the touch bar 201. The indicator 210 includes an LED, for example, and causes the position corresponding to the user operation to light up in red or the like. In FIG. 4, it is shown that the finger F is in contact with the area around a position A1 of the touch bar 201, and the corresponding position in the indicator 210 is lit up.

When the user performs a contact operation which is a slide operation on any location of the touch bar 201, the receiver 202 receives one-dimensional operation position information. The outputter 204 provides the operation position information to the parameter setter 102. The parameter setter 102 continuously changes a predetermined parameter of the electronic musical instrument 1 according to the operation position information. For example, when the user performs a continuous operation (slide operation) on the operation area 201a of the touch bar 201, the setting value of a parameter continuously changes in correspondence with the operation.

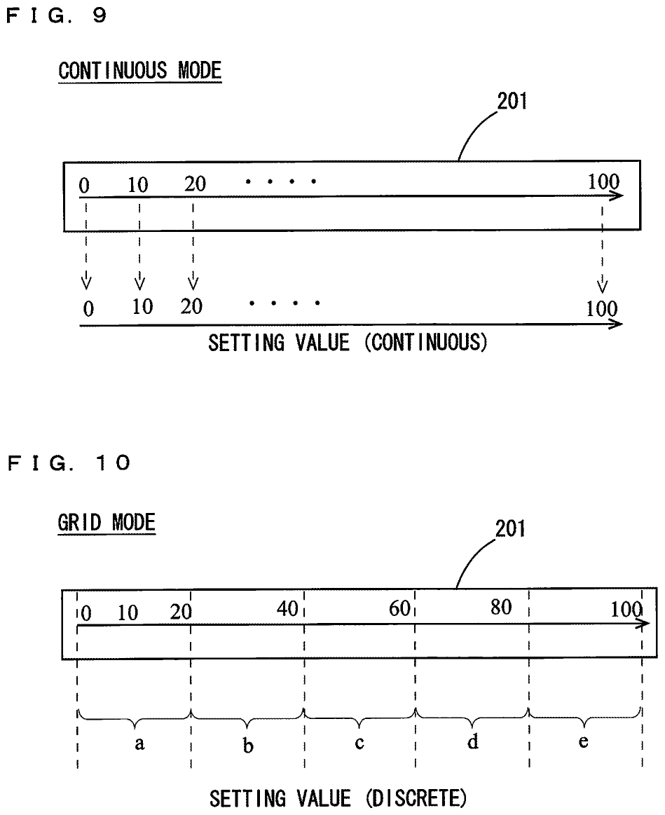

FIG. 9 is a conceptual diagram of a parameter setting in the continuous mode. Suppose that continuous operation positions 0 to 100 are defined on the touch bar 201 as shown in the diagram, for example. Accordingly, in the continuous mode, a parameter is set with use of the continuous setting values 0 to 100, for example. For example, when the user performs a slide operation from the operation position 20 to the operation position 40, a setting value continuously changes from 20 to 40.

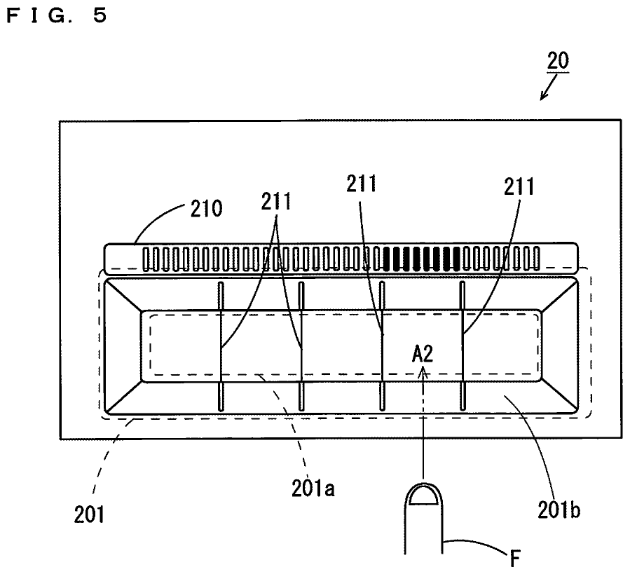

FIG. 5 shows the input device 20 operating in the grid mode. In the grid mode, section indicators 211 are displayed on the touch bar 201. The touch bar 201 includes an LED for displaying the section indicators 211, for example. Thus, on the touch bar 201, the section indicators 211 are lit up by the lines extending in a direction orthogonal to the direction in which the one-dimensional operation area 201a extends. In the example of FIG. 5, since the touch bar 201 is sectioned into five sections (grids), the four section indicators 211 are displayed. In FIG. 5, it is shown that the finger F is in contact with the area around a position A2 of the touch bar 201. That is, because the finger F is in contact with the second grid from the rightmost grid, the position in the indicator 210 corresponding to the second grid from the rightmost grid is lit up in response to this operation. In this manner, in the grid mode, the indicator 210 clearly indicates the range corresponding to the section corresponding to the operation position.

When the user performs a contact operation, which is a discontinuous operation, on any grid of the touch bar 201, the receiver 202 receives one-dimensional operation position information. The outputter 204 provides the operation position information to the parameter setter 102. The parameter setter 102 refers to the grid correspondence table T1 and acquires the setting value corresponding to the operation position information. The parameter setter 102 sets a parameter based on the setting value acquired from the grid correspondence table T1.

FIG. 10 is a conceptual diagram of the parameter setting in the grid mode. Suppose that continuous operation positions 0 to 100 are defined on the touch bar 201 as shown in the diagram, for example. Accordingly, in the grid mode, a setting value ‘a’ is associated with the operation positions 0 to 20, a setting value ‘b’ is associated with the operation positions 21 to 40, a setting value ‘c’ is associated with the operation positions 41 to 60, a setting value ‘d’ is associated with the operation positions 61 to 80, and a setting value ‘e’ is associated with the operation positions 81 to 100, for example. This association is stored in the grid association table T1. That is, in the grid correspondence table T1, a plurality of sections of the operation area 201a are associated with setting values in a one-to-one correspondence.

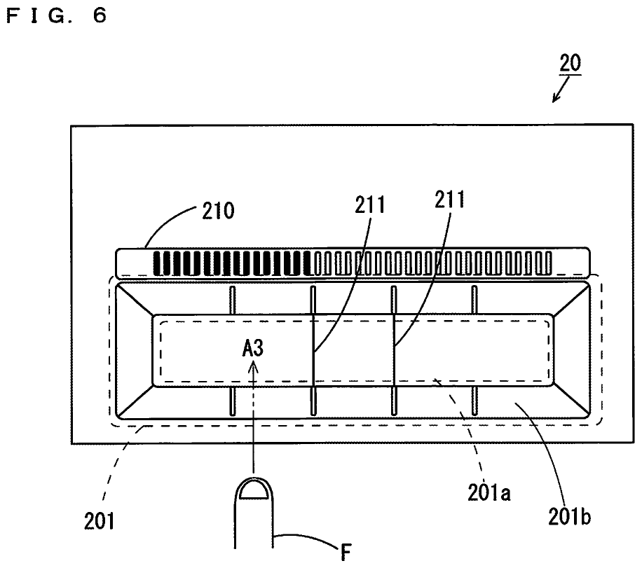

FIG. 6 is a diagram showing another inventive example of the input device 20 operating in the grid mode. In the example of FIG. 6, since the touch bar 201 is sectioned into three grids, two section indicators 211 are displayed. While the section indicators 211 are displayed at equal intervals in the example shown in FIG. 5, the section indicators 211 are displayed at unequal intervals in the example shown in FIG. 6. In FIG. 6, it is shown that the finger F is in contact with the area around a position A3 of the touch bar 201. That is, because the finger F is in contact with the leftmost grid, the position in the indicator 210 corresponding to the leftmost grid is lit up in response to this operation. In this example, the input device 20 can receive any one of 3 types of setting values.

### [5] Mode Switching Method and Parameter Setting Method

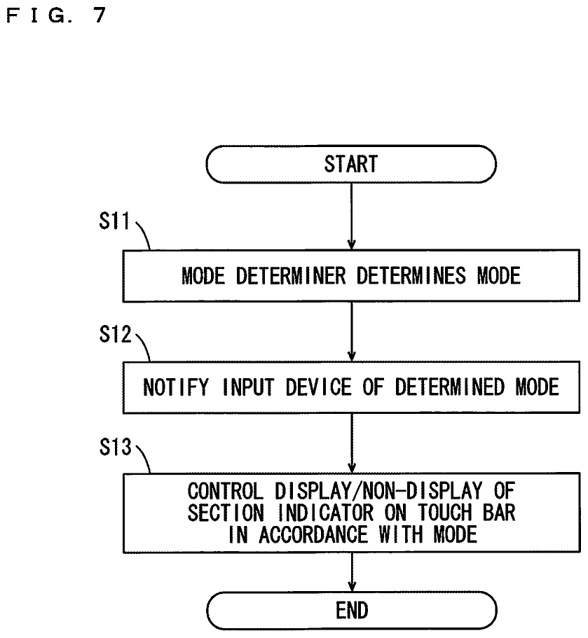

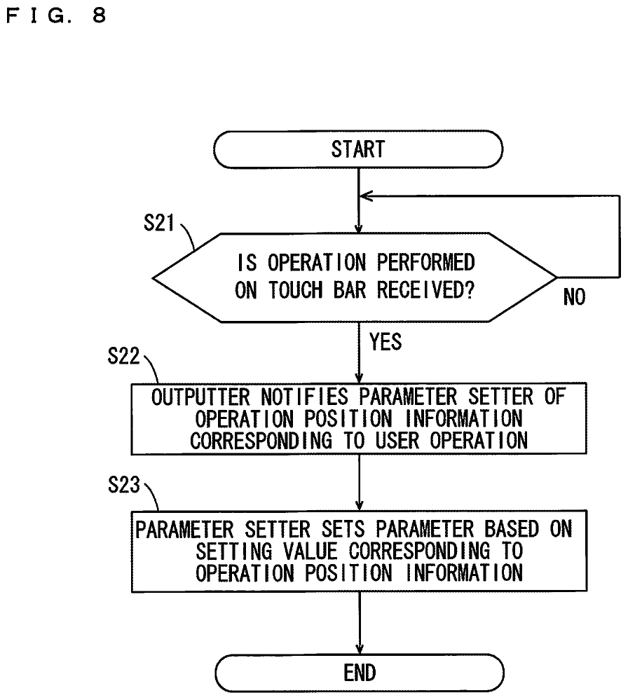

Next, the mode switching method and the parameter setting method according to the present embodiment will be described with reference to FIGS. 7 and 8. The mode switching method shown in FIG. 7 and the parameter setting method shown in FIG. 8 are performed by the program P1 and each function of the input device 20. Reference will be made to FIG. 7. First, in the step S11, the mode determiner 101 determines the mode of the input device 20. The mode determiner 101 determines the mode of the input device 20 based on a current tone color setting of the electronic musical instrument 1, for example.

Next, in the step S12, the mode determiner 101 notifies the input device 20 of the determined mode. In the input device 20, the switcher 205 switches the mode of the input device 20 based on mode designation information provided from the mode determiner 101. In a case in which the mode designated by the mode designation information is the grid mode, the switcher 205 instructs the section presenter 203 to display the section indicator 211. In a case in which the mode designated by the mode designation information is the continuous mode, the switcher 205 instructs the section presenter 203 not to display the section indicator 211. Then, in the step S13, when the mode is switched to the grid mode, the section presenter 203 displays the section indicator 211 on the touch bar 201 based on a display instruction received from the switcher 205. When the mode is switched to the continuous mode, the section presenter 203 does not display the section indicator 211 on the touch bar 201 based on a non-display instruction received from the switcher 205.

Reference will be made to FIG. 8. In the step S21, whether the receiver 202 has received an operation performed on the touch bar 201 is determined. In a case in which an operation performed on the touch bar 201 is received, in the step S22, the outputter 204 notifies the parameter setter 102 of operation position information corresponding to the user operation. Next, in the step S23, the parameter setter 102 sets a parameter based on a setting value corresponding to operation position information in accordance with a mode. In a case in which the mode of the input device 20 is the continuous mode, the parameter setter 102 sets a parameter based on a continuous setting value corresponding to operation position information. In a case in which the mode of the input device 20 is the grid mode, the parameter setter 102 refers to the grid correspondence table T1 to acquire a setting value corresponding to operation position information. Then, the parameter setter 102 sets a parameter based on the acquired setting value.

### [6] Effects of Embodiments

(1) The above-mentioned input device 20 of the present embodiment includes the touch bar 201 having the operation area 201a for receiving a contact operation performed by a user, the switcher 205 that switches between a first mode (continuous mode) in which a continuously changing value is received in response to a user operation and a second mode different from the first mode, and the section presenter 203 that presents the section indicator 211 representing the plurality of sections of the operation area 201a of the touch bar 201 during the second mode. Thus, in the second mode, the user can easily recognize the boundary where the setting value changes. Thus, the input device 20 of the present embodiment can improve the operability of the slider.

(2) The section indicator 211 may be displayed in the operation area 201a. Because the section indicator 211 is displayed in the operation area 201a, the user can easily recognize the boundaries of the sections and easily perform an operation.

(3) The operation area 201a may be an area extending in a one-dimensional direction, and the section indicator 211 may be the line extending in a direction orthogonal to the one-dimensional direction. The user can easily recognize the boundaries of the sections and easily performs an operation.

(4) The input device 20 may further include the outputter 204 that outputs operation position information in response to a contact operation performed on the operation area 201a by the user. An appliance including the input device 20 can perform a desired process in accordance with the operation position information.

(5) The input device 20 may have the indicator 210 that displays an operation position at a position corresponding to the operation position in response to a contact operation performed on the operation area 201a by the user. Because the position of a user operation is visually shown, the user can easily perform an operation.

(6) The indicator 210 may clearly indicate the range corresponding to a section corresponding to an operation position in the grid mode. In the grid mode, because the operation range is clearly shown, the user can easily perform an operation.

(7) The second mode is the grid mode in which a discontinuous value is receivable in response to a user operation. In the mode in which a discontinuous value is received, the user can easily recognize the position where the setting value changes, and the operability is improved.

(8) The electronic musical instrument 1 of the present embodiment includes the input device 20 of any of the above-mentioned (4), and the parameter setter 102 that sets a music parameter in accordance with operation position information output by the outputter 204. An electronic musical instrument excellent in the operability for setting a music parameter can be provided.

(9) Setting values may be associated with a plurality of sections of the operation area 201a in a one-to-one correspondence, and the parameter setter 102 may set a musical parameter based on a setting value corresponding to a section to which the operation position information belongs in the grid mode. In the grid mode, a discrete music parameter corresponding to a section is set.

### [7] Other Embodiments

While an electronic keyboard musical instrument is described as an appliance to which the input device 20 of the present embodiment is applied by way of example in the above-mentioned embodiment, this is merely one example. The input device 20 of the present embodiment can be applied to another electronic musical instrument, another device, another appliance or the like. The input device may be applied to an electronic drum, a mixer or an audio apparatus, for example.

While the input device 20 of the above-mentioned embodiment has the grid mode in which a touch operation is received in addition to the continuous mode in which a continuous operation is received by way of example, this is merely one example. As an input detection mode other than the continuous mode, another mode in which a user performs an input operation while referring to the section indicator 211 may be utilized.

In the above-mentioned embodiment, the input device 20 is utilized as a device that discretely sets a parameter of the electronic musical instrument 1 in the grid mode. In another embodiment, the input device 20 may function as a plurality of switches for changing different parameters in the grid mode.

In the above-mentioned embodiment, the section presenter 203 presents visual information (a section indicator 211) as section information. In another embodiment, the section presenter 203 may present section information to a user using a sound, vibration or the like in the grid mode. In case of presentation with use of a sound, a different presentation sound for each section may be output from a speaker. In case of presentation with use of vibration, an actuator that generates vibration may further be provided, and vibration having a different period or different intensity for each section may be excited. Further, the indicator 210 may be used as a section indicator.

In the above-mentioned embodiment, the touch bar 201 having the one-dimensional operation area 201a is described as an operator, by way of example. In another embodiment, an operator may be a touch panel having a two-dimensional operation area.

In the above-mentioned embodiment, the input device 20 is configured to include the receiver 202, the section presenter 203, the outputter 204 and the switcher 205, by way of example. That is, each component for controlling an operation of the touch bar 21 is configured to be provided in the input device 20, by way of example. In another embodiment, part or all of the functions included in these components may be configured not to be provided in the input device 20. For example, part or all of the functions of these components may be executed by the CPU 16 of the electronic musical instrument 1, or may be controlled by a server connected to the electronic musical instrument 1.

While the section indicator 211 is displayed in the operation area 201a of touch bar 201 in the above-mentioned embodiment, the section indicator 211 may be displayed in the bezel 201b which is an non-operation area. For this reason, in the bezel 201b, a structure (an indicator, a projection, a concave portion or the like) with which the section indicator 211 can be displayed may be provided, or an LED display unit or a print unit may be provided as a function for displaying the section indicator 211.

### [8] Correspondences Between Constituent Elements in Claims and Parts in Preferred Embodiments

In the following paragraphs, non-limiting examples of correspondences between various elements recited in the claims below and those described above with respect to various preferred embodiments of the present disclosure are explained. In the above-mentioned embodiment, the touch bar 201 is an example of an operator. In the above-mentioned embodiment, the continuous operation or the slide operation is an example of a first operation, and the touch operation is an example of a second operation. Further, in the above-mentioned embodiment, the continuous mode is an example of a first mode, and the grid mode is an example of a second mode.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. An input device comprising:
an operator including an operation area configured to receive a contact operation performed by a user;
a mode switcher that switches between a first mode where a continuously changing value is receivable in response to an operation performed on the operator and a second mode different from the first mode; and
a section presenter that presents section information representing a plurality of sections of the operation area during the second mode.

2. The input device according to claim 1, wherein
the section information is displayed in the operation area.

3. The input device according to claim 2, wherein:
the operation area is an area extending in a one-dimensional direction, and
the section information is a line extending in a direction orthogonal to the one-dimensional direction.

4. The input device according to claim 3, wherein the operator is a touch bar.

5. The input device according to claim 1, further comprising an outputter that outputs operation position information in response to a contact operation performed on the operation area by the user.

6. The input device according to claim 1, wherein the operator includes an indicator that displays an operation position corresponding to a contact operation performed on the operation area by the user.

7. The input device according to claim 6, wherein the indicator visibly indicates a range corresponding to a section, among the plurality of sections, corresponding to an operation position in the second mode.

8. The input device according to claim 1, wherein in the second mode, a discontinuous value is receivable in response to an operation performed on the operator.

9. An input device comprising:
an operator including an operation area configured to receive a contact operation performed by a user;
a processor or a circuit configured to:
switch between a first mode where a continuously changing value is receivable in response to an operation performed on the operator and a second mode different from the first mode; and
present section information representing a plurality of sections of the operation area during the second mode.

10. An electronic musical instrument comprising:
a controller including a processor; and
an input device comprising:
an operator including an operation area configured to receive a contact operation performed by a user;
a mode switcher that switches between a first mode where a continuously changing value is receivable in response to an operation performed on the operator and a second mode different from the first mode;
a section presenter that presents section information representing a plurality of sections of the operation area during the second mode; and
an outputter that outputs operation position information in response to a contact operation performed on the operation area by the user,
where the controller is configured to set a music parameter in accordance with operation position information output by the outputter.

11. The electronic musical instrument according to claim 10, wherein:
setting values are associated with the plurality of sections of the operation area in a one-to-one correspondence, and
the controller sets the musical parameter based on a setting value, among the setting values, corresponding to each of the plurality of sections in the second mode.
